(19) United States
(12) Patent Application Publication
(10) Pub. No.: US 2014/0270844 A1
(43) Pub. Date: Sep. 18, 2014

(54) Doctor blade assembly and alignment method

(71) Applicant: MITSUBISHI KAGAKU IMAGING CORPORATION, San Fernando, CA (US)

(72) Inventor: Kozo Ishio, Japan (JP)

(73) Assignee: Mitsubishi Kagaku Imaging Corporation, San Fernando, CA (US)

(21) Appl. No.: 13/815,743

(22) Filed: Mar. 15, 2013

(51) Int. Cl. G03G 15/00; G03G 15/08

(52) U.S. Cl. CPC G03G 15/0812
USPC 399/109; 399/284

(57) ABSTRACT

There is provided a doctor blade assembly and method for alignment in a toner hopper of a toner printer cartridge. The doctor blade assembly has a holder portion. The holder portion has a first mounting end and a second mounting end. The holder portion further has a pair of recessed openings formed in the first mounting end and the second mounting end, respectively. The holder portion further has a pair of alignment elements each having an alignment through hole and each configured to fit in and correspond to each respective recessed opening. The doctor blade assembly further has a blade portion attached to the holder portion. The doctor blade assembly further has a pair of fastener members each configured for insertion through the alignment through hole and through the recessed opening.

### BACKGROUND

a. Field of the Invention

The disclosure relates to electrophotographic imaging devices, and in particular, devices and methods for manufacturing or remanufacturing toner printer cartridges

b. Background Art

Printer cartridges, such as toner printer cartridges, are used in various electrophotographic imaging devices, such as laser printers, copiers, facsimile machines, and multifunction imaging devices. Once original equipment manufacturer (OEM) toner printer cartridges are used, they are often recycled and remanufactured. The process of remanufacturing a toner printer cartridge may include cleaning the cartridge, repairing damaged parts, replacing worn parts, reassembling with new parts, and replenishing the cartridge with toner. The process of remanufacturing a toner printer cartridge requires that the toner printer cartridge be disassembled so that access to the various component parts may be achieved, and further requires that the toner printer cartridge be reassembled for subsequent use.

The component parts of toner printer cartridges typically include a doctor blade or doctor bar, a toner hopper, a waste hopper, a wiper blade, a primary charge roller (PCR), a developer roller, and an organic photoconductive (OPC) drum. The term “doctor blade” is a commonly used term in the toner printer cartridge manufacturing and remanufacturing industries and refers to an elongated material that usually includes an elongated holder or rod with an elongated blade attached to the elongated holder or rod. The elongated holder or rod is usually made of metal, and the elongated blade may be made of plastic or metal. The elongated blade may be positioned at an angle from the elongated holder or rod and may be positioned proximate to the developer roller with a predetermined distance.

When the toner printer cartridge is in operation, the doctor blade or doctor blade assembly is typically stationary while the developer roller rolls next to the doctor blade. The doctor blade or doctor blade assembly ensures that the right amount of toner sticks to the developer roller. However, not all toner may be absorbed by the developer roller. The toner that is not absorbed by the developer roller typically accumulates around the developer roller. Since the doctor blade and the developer roller are separated by a relatively small predetermined space, the blade controls the thickness of the toner that adheres to the developer roller by scraping off toner that is not absorbed by the developer roller. If there is an excess amount of toner on the developer roller, the doctor blade scrapes off the excess amount. The developer roller then transfers the toner to the OPC drum. The OPC drum that is coated with toner then rolls over a sheet of paper, which is usually given a negative charge by the PCR. The charge of the paper is typically less negative than the charge of the toner, and thus the paper attracts the toner. The toner may be embedded on the paper according to the print pattern.

The doctor blade or doctor blade assembly and the developer roller are usually detached from the toner printer cartridge during the remanufacturing process for cleaning. After cleaning, the doctor blade or doctor blade assembly and the developer roller may be reassembled together usually manually with a screw driver. An assembler or user may align or position the doctor blade above the developer roller. The assembler or user may press on one side of the doctor blade or doctor blade assembly and then attach with fastener or attachment means, such as screws, the same side of the doctor blade to the toner printer cartridge. The assembler or user may then execute the same steps on the remaining side. Aligning and positioning the doctor blade or doctor blade assembly during replacement and remanufacture may require that the doctor blade or doctor blade assembly be aligned or positioned within a tenth of millimeters of an acceptable alignment or position point to maximize print quality during printing. Many known OEM toner printer cartridges are designed to have a doctor blade or doctor blade assembly that may have the capability of being adjustable in order to adjust the doctor blade position. Thus, it may be difficult for the remanufacturer to manually align the doctor blade or doctor blade assembly to the correct position.

Known methods of assembly, manufacture, or remanufacture of toner printer cartridges may not provide a uniform distance between the doctor blade or doctor blade assembly and the developer roller from one side of the doctor blade to the other. As a result, the print quality may be affected, as the toner level on the developer roller is not effectively regulated by the doctor blade. One side of the developer roller may produce darker images than the other, or vice-versa. Moreover, known methods of assembly, manufacture, or remanufacture of toner printer cartridges, such as positioning or aligning a doctor blade or doctor blade assembly, may require an assembler or user to manually align and position the doctor blade or doctor blade assembly and may result in misalignment or damage to the doctor blade or doctor blade assembly. For example, an assembler or user may have to manually hold the doctor blade or doctor blade assembly in order to tighten fasteners such as screws to secure the doctor blade or doctor blade assembly to the toner hopper.

In addition, known methods of assembly or remanufacture of toner printer cartridges may require permanent attachment of two or more spacers, inserts, shims, or other spacing elements within the gap or area formed between the doctor blade or doctor blade assembly and the printer cartridge body in order to maintain a desired gap or area distance. The use of such permanent spacers, inserts, shims, or other spacing elements may increase the overall cost and complexity and decrease the overall efficiency of the assembly, manufacturing, or remanufacturing processes. Moreover, such spacers, inserts, shims, or spacing elements may have to have a required thickness that may limit the type of spacer, insert, shim, or spacing element that may be used.

In addition, known methods of assembly or remanufacture of toner printer cartridges may require the use of fixture elements to hold the doctor blade or doctor blade assembly and/or toner hopper and/or toner printer cartridge in place while positioning and aligning the doctor blade or doctor blade assembly. The use of such fixture elements may increase the overall cost and complexity and decrease the overall efficiency of the assembly, manufacturing, or remanufacturing processes.

Accordingly, there is a need for an improved doctor blade assembly and method for aligning doctor blade assemblies in toner hoppers of toner printer cartridges, that overcomes the issues associated with known devices and methods.

### SUMMARY

This need for an improved doctor blade assembly and method for aligning doctor blade assemblies in toner hoppers of toner printer cartridges is satisfied.

There is provided in one embodiment a doctor blade assembly for alignment in a toner hopper of a toner printer cartridge. The doctor blade assembly comprises a holder portion. The holder portion comprises a first mounting end and a second mounting end. The holder portion further comprises a pair of recessed openings formed in the first mounting end and the second mounting end, respectively. The holder portion further comprises a pair of alignment elements each having an alignment through hole and each configured to fit in and correspond to each respective recessed opening. The doctor blade assembly further comprises a blade portion attached to the holder portion. The doctor blade assembly further comprises a pair of fastener members each configured for insertion through the alignment through hole and through the recessed opening.

There is provided in another embodiment a toner printer cartridge. The toner printer cartridge comprises a toner hopper. The toner printer cartridge further comprises a doctor blade assembly for alignment on the toner hopper. The doctor blade assembly comprises a holder portion. The holder portion comprises a first elongated positioning portion having a first mounting end and a second mounting end, a second elongated positioning portion substantially perpendicular to the first elongated positioning portion, a pair of recessed openings formed in the first mounting end and the second mounting end, respectively, a pair of alignment elements each having an alignment through hole and each configured to fit in and correspond to each respective recessed opening. The doctor blade assembly further comprises a blade portion attached along the first elongated positioning portion between the pair of recessed openings. The doctor blade assembly further comprises a pair of fastener members each configured for insertion through the alignment through hole of the alignment elements and through the recessed openings. The doctor blade assembly does not require use of a spacing element or a fixture element to align or to adjust a desired alignment position of the doctor blade assembly in the toner hopper of the toner printer cartridge.

There is provided in another embodiment a method for aligning a doctor blade assembly in a toner hopper of a toner printer cartridge. The method comprises the step of cutting a pair of recessed openings through a first mounting end and a second mounting end of a holder portion of a doctor blade assembly, and obtaining a pair of removable cut-out portions corresponding to the pair of recessed openings. The method further comprises the step of forming a predetermined alignment through hole in each of the cut-out portions, and obtaining an alignment element. The method further comprises the step of positioning the doctor blade assembly in a toner hopper of a toner printer cartridge, wherein the toner hopper has a pair of positioning pins at each end. The method further comprises the step of aligning the respective alignment through holes, the recessed openings, and the positioning pins along a substantially straight alignment pathway. The method further comprises the step of inserting a pair of fastener members through the respective alignment through holes and the recessed openings to set the doctor blade assembly in a desired alignment position.

The above description sets forth, rather broadly, a summary of the disclosed embodiments so that the detailed description that follows may be better understood and contributions of the invention to the art may be better appreciated. Some of the disclosed embodiments may not include all of the features or characteristics listed in the above summary. There may be, of course, other features of the disclosed embodiments that will be described below and may form the subject matter of claims. The features, functions, and advantages that have been discussed can be achieved independently in various embodiments of the disclosure or may be combined in yet other embodiments further details of which can be seen with reference to the following description and drawings.

### DESCRIPTION OF DRAWINGS

The invention can be better understood with reference to the following detailed description taken in conjunction with the accompanying drawings which illustrate preferred and exemplary embodiments, but which are not necessarily drawn to scale, wherein:

FIG. 1 shows a front perspective view of a known doctor blade assembly for use in a toner printer cartridge;

FIG. 2 shows a front perspective view of a known wiper blade assembly for use in a toner printer cartridge;

FIG. 3A shows a front perspective view of a known doctor blade assembly being positioned in a toner printer cartridge with use of a fixture element and a spacing element;

FIG. 3B shows an enlarged front perspective view of the circle 3B of FIG. 3A and shows a slot opening on the known doctor blade assembly to enable position adjustment of the known doctor blade assembly;

FIG. 4A shows a front perspective view of one of the embodiments of a doctor blade assembly of the disclosure in a nonaligned position and having alignment elements and recessed openings with a rectangle shape;

FIG. 4B shows a front perspective view of the doctor blade assembly of FIG. 4A in a partially aligned position in a toner hopper in a toner printer cartridge;

FIG. 4C shows an enlarged front perspective view of the circle 4C of FIG. 4B showing an alignment element and a recessed opening with a rectangle shape;

FIG. 4D shows a front perspective view of the doctor blade assembly of FIG. 4A in a desired alignment position in a toner hopper of a toner printer cartridge;

FIG. 5A shows a front plan view of an embodiment of an alignment element having a rectangle shape and showing a symmetry line measurement position at a height (x/2);

FIG. 5B shows a front plan view of another embodiment of an alignment element having a rectangle shape and showing a symmetry line measurement position at a height (x/3);

FIG. 5C shows a front plan view of another embodiment of an alignment element having a rectangle shape and showing a symmetry line measurement position at a height (x/4);

FIG. 6A shows a front perspective view of another one of the embodiments of a doctor blade assembly of the disclosure in a partially aligned position in a toner hopper and having alignment elements with a trapezoid shape;

FIG. 6B shows an enlarged front perspective view of the circle 6B of FIG. 6A showing an alignment element and a recessed opening with a trapezoid shape;

FIG. 6C shows a front perspective view of the doctor blade assembly of FIG. 6A in a desired alignment position in a toner hopper;

FIG. 7A shows a front plan view of an embodiment of an alignment element having a trapezoid shape and showing a symmetry line measurement position at a first height (x/4);

FIG. 7B shows a front plan view of another embodiment of an alignment element having a trapezoid shape and showing a symmetry line measurement position at a first height (x/3);

FIG. 7C shows a front plan view of another embodiment of an alignment element having a trapezoid shape and showing a symmetry line measurement position at an height (x/2);

FIG. 7D shows a front plan view of another embodiment of an alignment element having a trapezoid shape and showing a symmetry line measurement position at a second height (x/3);

FIG. 7E shows a front plan view of another embodiment of an alignment element having a trapezoid shape and showing a symmetry line measurement position at a second height (x/4);

FIG. 8A shows a front perspective view of another one of the embodiments of a doctor blade assembly of the disclosure in a partially aligned position in a toner hopper and having alignment elements with a triangle shape;

FIG. 8B shows an enlarged front perspective view of the circle 8B of FIG. 8A showing an alignment element and a recessed opening with the triangle shape;

FIG. 8C shows a front perspective view of the doctor blade assembly of FIG. 8A in a desired alignment position in a toner hopper;

FIG. 9 shows an enlarged back perspective view of an alignment element having a triangle shape;

FIG. 10A shows an enlarged partial front perspective view of an embodiment of the doctor blade assembly in a nonaligned position and showing a cut-out portion prior to being formed into an alignment element;

FIG. 10B shows a right side view of the doctor blade assembly of FIG. 10A in a partially aligned position;

FIG. 10C shows a right side view of the doctor blade assembly of FIG. 10B in a desired alignment position in contact with a developer roller and aligned in a toner hopper in a toner printer cartridge;

FIG. 10D shows an enlarged partial front perspective view of another embodiment of the doctor blade assembly in a nonaligned position with another embodiment of an alignment through hole;

FIG. 10E shows an enlarged front perspective view of another embodiment of the doctor blade assembly of the disclosure in a nonaligned position and having an alignment element and a recessed opening with straight sidewalls; and,

FIG. 11 shows an illustration of a flow diagram of an embodiment of a method of the disclosure.

### DETAILED DESCRIPTION

Disclosed embodiments will now be described more fully herein after with reference to the accompanying drawings, in which some, but not all disclosed embodiments are shown. Indeed, several different embodiments may be provided and should not be construed as limited to the embodiments set forth herein. Rather, these embodiments are provided so that this disclosure will be thorough and complete and will fully convey the scope of the disclosure to those skilled in the art. It is to be understood that other embodiments may be utilized and structural changes may be made without departing from the scope of the invention. Also, it is to be understood that the phraseology and terminology employed herein are for the purpose of description and should not be regarded as limiting.

The order in which the steps are presented below is not limited to any particular order and does not necessarily imply that they have to be performed in the order presented. It will be understood by those of ordinary skill in the art that the order of these steps can be rearranged and performed in any suitable manner. It will further be understood by those of ordinary skill in the art that some steps may be omitted or added and still fall within the spirit of the invention.

The disclosed embodiments provide various devices and methods for manufacturing and remanufacturing printer cartridges, such as toner printer cartridges, and in particular, for aligning and positioning a doctor blade in a toner hopper of a toner printer cartridge or remanufactured toner printer cartridge. The disclosed embodiments of the devices and methods may be used with toner printer cartridges that can be used in laser printer models, such as, Hewlett Packard (HP) Company families of laser printers, for example, HP 4600, HP4700, HP5500, HP2600, HP CP1518, HP CP2025, HP CP3525, HP CP4525, HP CP5525, HP CP6015, HP CP1025, or may also be used with other suitable toner printer cartridges. It is known that a color printer cartridge requires accurate doctor blade alignment to maximize the print quality and the toner consumption.

Embodiments of a doctor blade assembly 10a (see FIG. 4A) for alignment in a toner hopper 56a (see FIG. 4B) of a toner printer cartridge 11 (see FIG. 4B), and a method 200 (see FIG. 11) for aligning a doctor blade assembly 10a (see FIG. 4A) in a toner hopper 56a (see FIG. 4B) of a toner printer cartridge 11 (see FIG. 4B) are provided. Embodiments of the doctor blade assembly 10a (see FIG. 4A) and method 200 (see FIG. 11) enable placement and alignment of the doctor blade assembly 10a at a desired alignment position 80a (see FIG. 4D) without having to use a spacing element 36 (see FIG. 3A) or a fixture element 37 (see FIG. 3A) to align or to adjust a desired alignment position 80a (see FIG. 4D) of the doctor blade assembly 10a in the toner hopper 34 (see FIG. 4D) of the toner printer cartridge 11 (see FIG. 4D).

The sizes, shapes, orientations, and positions of the doctor blade assembly 10a (see FIG. 4B), 10b (see FIG. 6A), and 10c (see FIG. 8A) may vary depending on the design of the toner hopper 56a (see FIG. 4B), 56b (see FIG. 6A), and 56c (see FIG. 8A) and the design and model of the toner printer cartridge 11 (see FIG. 4B), such as a newly manufactured toner printer cartridge or a remanufactured toner printer cartridge intended to be used embodiments of the doctor blade assembly disclosed herein.

Referring to the Figures, FIG. 1 shows a front perspective view of a known doctor blade assembly 10 for use in known toner printer cartridges 34 (see FIG. 3A). As shown in FIG. 1, the known doctor blade assembly 10 comprises a holder portion 18 having a first mounting end 12a and a second mounting end 12b. The first mounting end 12a and the second mounting end 12b each have an opening 14 configured to receive a fastener member 16 for attachment to a toner hopper 56 (see FIG. 3A) of a known toner printer cartridge 34 (see FIG. 34). As shown in FIG. 1, the known doctor blade assembly 10 further comprises a blade portion 20 attached to the holder portion 18 along attachment portion 22.

FIG. 2 shows a front perspective view of a known wiper blade assembly 24 typically used in known toner printer cartridges 34 (see FIG. 3A). As shown in FIG. 2, the known wiper blade assembly 24 comprises a support portion 30 having a first mounting end 26a and a second mounting end 26b. The first mounting end 26a and the second mounting end 26b each have an opening 28 configured to receive a fastener member 16 (see FIG. 1) for attachment to a toner hopper 56 (see FIG. 3A) of a known toner printer cartridge 34 (see FIG. 34). As shown in FIG. 2, the known wiper blade assembly 24 further comprises a blade portion 32 attached to the holder portion 30.

FIG. 3A shows a front perspective view of a known doctor blade assembly 10 being positioned in a toner hopper 56 of a known toner printer cartridge 34. As shown in FIG. 3A, the known doctor blade assembly 10 has the holder portion 18 and the attached blade portion 20. The holder portion 18 has slot openings 38 (see FIG. 3A) formed in each end and adapted to receive fastener members 16 (see FIG. 3A). FIG. 3A further shows the known toner printer cartridge 34 positioned within a fixture element 37, such as a known doctor blade alignment fixture, that may be used to assist in positioning and aligning the doctor blade assembly 10. FIG. 3A further shows a spacing element 36 positioned on the toner hopper 56 for use in positioning and aligning the doctor blade assembly 10. FIG. 3B shows an enlarged front perspective view of the circle 3B of FIG. 3A and shows the slot opening 38 on the holder portion 18 of the known doctor blade assembly 10 configured to receive fastener member 16 and configured to enable position adjustment of the known doctor blade assembly 10.

As disclosed herewith, embodiments of the doctor blade assembly 10a (see FIG. 4A), doctor blade assembly 10b (see FIG. 6A), doctor blade assembly 10c (see FIG. 8A), for alignment in a toner hopper 56a (see FIG. 4B) of a toner printer cartridge 11 (see FIG. 4B) are provided. FIGS. 4A-4D show one of the embodiments of the doctor blade assembly 10a. FIG. 4A shows a front perspective view of the doctor blade assembly 10a in a pre-aligned position 62 and having alignment elements 40 with a rectangle shape 44. As shown in FIG. 4A, the doctor blade assembly 10a comprises a holder portion 18a. As shown in FIG. 4A, the holder portion 18a comprises a first elongated positioning portion 110 having a first mounting end 12a and a second mounting end 12b. As further shown in FIG. 4A, the holder portion 18a comprises a second elongated positioning portion 112 substantially perpendicular to the first elongated positioning portion 100.

As further shown in FIG. 4A, the holder portion 18a comprises a pair of recessed openings 48, such as in the form of recessed openings 48a, having a rectangle shape 44, and formed at portions 54a in the first mounting end 12a and in the second mounting end 12b, respectively. As further shown in FIG. 4A, each recessed opening 48 further comprises an outer profile 77a (see FIG. 4C) and an inner profile 78a (see FIG. 4C). As shown in FIG. 4C, the outer profile shape 77a and the inner profile shape 78a are in a rectangle shape 44. Although the recessed opening 48 shown in the embodiment of FIG. 4C has a rectangle shape 44, the recessed opening 48 may have an outer profile and an inner profile in another geometric shape, such as including a trapezoid shape 90 (see FIG. 6B), a triangle shape (see FIG. 8B), a square shape (not shown), a pentagon shape (not shown), a hexagon shape (not shown), a circle shape (not shown), an oval shape (not shown), or another suitable shape.

As further shown in FIG. 4A, each recessed opening 48, such as in the form of recessed opening 48a, has an open portion 50a, angled sidewalls 52, such as first angled sidewall 52a (see FIG. 4C), second angled sidewall 52b (see FIG. 4C), third angled sidewall 52c (see FIG. 4C), and fourth angled sidewall 52d (see FIG. 4C). Although the recessed opening 48 shown in the embodiment of FIG. 4C has angled sidewalls, the recessed opening 48 may in another embodiment have straight sidewalls, such as shown in FIG. 10E. FIG. 10E shows a recessed opening 48, such as in the form of recessed opening 48d, having a first straight sidewall 124a, a second straight sidewall 124b, a third straight sidewall 124c, and a fourth straight sidewall 124d. In another embodiment, the recessed opening 48 may have a combination of one or more angled sidewalls and one or more straight sidewalls.

As further shown in FIG. 4A, the holder portion 18a of the doctor blade assembly 10a comprises a pair of alignment elements 40, such as in the form of alignment elements 40a. As further shown in FIG. 4A, each alignment element 40 has an alignment through hole 46a, and each alignment element 40 is configured to fit in and correspond to each respective recessed opening 48. Each alignment element 40 (see FIG. 4A), such as in the form of alignment element 40a, has an outer profile shape 42 (see FIG. 4A), such as a rectangle shape 44 (see FIG. 4A). Although the alignment element 40 shown in the embodiment of FIG. 4A has a rectangle shape 44, the alignment element 40 may have an outer profile shape in another geometric shape such as including a trapezoid shape 90 (see FIG. 6B), a triangle shape (see FIG. 8B), a square shape (not shown), a pentagon shape (not shown), a hexagon shape (not shown), a circle shape (not shown), an oval shape (not shown), or another suitable shape. It is preferable that the shape of the alignment element 40 has an asymmetric side in at least one direction to prevent it from turning upside down when the alignment through hole 46a is not at the center of the alignment element 40. The alignment elements 40 may be in the form of chips or small pieces formed from cut-out portions 39 (see FIG. 10A) removed after the recessed openings 48 have been cut into the first mounting end 12a and the second mounting end 12b of the holder portion 18a. The alignment through hole 46a (see FIG. 4A) is preferably formed such as by drilling or cutting through the cut-out portion 39 to form and obtain the alignment element 40 (see FIG. 10A).

Each alignment element 40 (see FIG. 4C) further comprises a front side 58a (see FIG. 4C), a back side 60a (see FIG. 4C), a first edge 42a (see FIG. 5A), a second edge 42b (see FIG. 5A), a third edge 42c (see FIG. 5A), and a fourth edge 42d (see FIG. 5A), a first angled or beveled sidewall 43a (see FIG. 5A), a second angled or beveled sidewall 43b (see FIG. 5A), a third angled or beveled sidewall 43c (see FIG. 5A), and a fourth angled or beveled sidewall 43d (see FIG. 5A).

Although the alignment element 40 shown in the embodiment of FIG. 5A has angled sidewalls, the alignment element 40 may in another embodiment have straight sidewalls, such as shown in FIG. 10E. FIG. 10E shows an alignment element 40, such as in the form of alignment element 40d, having a first straight sidewall 122a, a second straight sidewall 122b, a third straight sidewall 122c, and a fourth straight sidewall 122d. In another embodiment, the alignment element 40 may have a combination of one or more angled sidewalls and one or more straight sidewalls.

The doctor blade assembly 10a (see FIG. 4A) further comprises a blade portion 20a (see FIG. 4A) attached along the first elongated positioning portion 110 (see FIG. 4A) between the pair of recessed openings 48 (see FIG. 4A). The doctor blade assembly 10a further comprises a pair of fastener members 16 (see FIG. 4A) each configured for insertion through the alignment through hole 46a (see FIG. 4A) of the alignment elements 40 and through the recessed openings 48. The fastener members 16 (see FIG. 10C) may be in the form of a screw 16a (see FIG. 10C), a bolt 16b (see FIG. 10E), or another suitable fastener member. The head of the fastener member 16 needs to be of a sufficient size so as to secure the alignment element 40 within the recessed opening 48. As shown in FIG. 10C, preferably, each fastener member 16 has a shaft length 109 greater than a thickness 111 of each alignment element 40, such as alignment element 40a (see FIG. 10C).

FIG. 4B shows a front perspective view of the doctor blade assembly 10a of FIG. 4A in a partially aligned position 64a in a toner hopper 56a of a toner printer cartridge 11. As shown in FIG. 4B, the doctor blade assembly 10a in the partially aligned position 64a shows each fastener member 16, alignment through hole 46a, and recessed opening 48 in a first alignment path 72a with each other and aligned with a positioning pin 70 in the toner hopper 56a. A positioning pin 70 is shown positioned at a first end 35a and at a second end 35b of the toner hopper 56a. The holder portion 18a of the doctor blade assembly 10a is shown in FIG. 4B positioned in the toner hopper 56a at first toner hopper portion 66 and at second toner hopper portion 68.

FIG. 4C shows an enlarged front perspective view of the circle 4C of FIG. 4B showing the alignment element 40, such as in the form of alignment element 40a, with the rectangle shape 44. As shown in FIG. 4C, the fastener member 16, alignment through hole 46a of the alignment element 40, and open portion 50a of the recessed opening 48, in the form of recessed opening 48a, having a rectangle shape 44, are aligned with the positioning pin 70 in the first alignment path 72a. The alignment element 40 and the recessed opening 48 are also aligned at a second alignment path 74a and a third alignment path 76a.

FIG. 4D shows a front perspective view of the doctor blade assembly 10a of FIG. 4A in a desired alignment position 80a where the doctor blade assembly 10a is fully aligned in the toner hopper 56a of the toner printer cartridge 11. As shown in FIG. 4D, each alignment element 40, such as in the form of alignment element 40a, is attached with the fastener member 16 to the holder portion 18a and in a fully attached position 82a such that the surface of the alignment element 40 is preferably flush with the surface of the first mounting end 12a (see FIG. 4A) and flush with the surface of the second mounting end 12b (see FIG. 4A) of the holder portion 18a. The doctor blade assembly 10a (see FIG. 4A) does not require use of a spacing element 36 (see FIG. 3A) or a fixture element 37 (see FIG. 3A) to align or to adjust the desired alignment position 80a (see FIG. 4D) of the doctor blade assembly 10a in the toner hopper 56a (see FIG. 4D) of the toner printer cartridge 11 (see FIG. 4D).

FIG. 6A shows a front perspective view of another one of the embodiments of a doctor blade assembly 10b of the disclosure in a partially aligned position 64b in a toner hopper 56b and having alignment elements 40, such as in the form of alignment elements 40b, with a trapezoid shape 90. As shown in FIG. 6A, the doctor blade assembly 10b comprises holder portion 18b having first mounting end 12a and second mounting end 12b, and further comprises blade portion 20b. As further shown in FIG. 6A, the holder portion 18b comprises a pair of recessed openings 48, such as in the form of recessed openings 48b, having a trapezoid shape 90, and formed at portions 54b in the first mounting end 12a and in the second mounting end 12b, respectively. As further shown in FIG. 6A, the doctor blade assembly 10b in the partially aligned position 64b shows each fastener member 16, alignment through hole 46b, and recessed opening 48 in a first alignment path 72b with each other, and aligned with a positioning pin 70 in the toner hopper 56a.

FIG. 6B shows an enlarged front perspective view of the circle 6B of FIG. 6A showing an alignment element 40, such as in the form of alignment element 40b, and a recessed opening 48, such as in the form of recessed opening 48b, both with a trapezoid shape 90. As shown in FIG. 6B, the fastener member 16, alignment through hole 46b of the alignment element 40, and open portion 50b of the recessed opening 48, are aligned with the positioning pin 70 in a first alignment path 72b. The alignment element 40 and the recessed opening 48 are also aligned at a second alignment path 74b and a third alignment path 76b. As further shown in FIG. 6B, the alignment element 40 further comprises a front side 58b and a back side 60b, and the recessed opening 48b comprises an outer profile shape 77b, an inner profile shape 78b, first angled sidewall 98a, a second angled sidewall 98b, a third angled sidewall 98c, and a fourth angled sidewall 98d.

FIG. 6C shows a front perspective view of the doctor blade assembly 10b of FIG. 6A in a desired alignment position 80b in a toner hopper 56b and shows the doctor blade assembly 10b fully aligned in the toner hopper 56b. As shown in FIG. 6C, each alignment element 40, such as in the form of alignment element 40b, is attached with the fastener member 16 to the holder portion 18b and is in a fully attached position 82b such that the surface of the alignment element 40 is preferably flush with the surface of the first mounting end 12a (see FIG. 6A) and flush with the surface of the second mounting end 12b (see FIG. 6A) of the holder portion 18b. The doctor blade assembly 10b (see FIG. 6C) does not require use of a spacing element 36 (see FIG. 3A) or a fixture element 37 (see FIG. 3A) to align or to adjust the desired alignment position 80b (see FIG. 6C) of the doctor blade assembly 10b in the toner hopper 56b (see FIG. 6C) of the toner printer cartridge 11 (see FIG. 4D).

FIG. 8A shows a front perspective view of another one of the embodiments of a doctor blade assembly 10c of the disclosure in a partially aligned position 64c in a toner hopper 56c and having alignment elements 40, such as in the form of alignment elements 40c, with a triangle shape 100. As shown in FIG. 8A, the doctor blade assembly 10c comprises holder portion 18c having first mounting end 12a and second mounting end 12b, and further comprises blade portion 20c. As further shown in FIG. 8A, the holder portion 18c comprises a pair of recessed openings 48, such as in the form of recessed openings 48c, having a trapezoid shape 90, and formed at portions 54c in the first mounting end 12a and in the second mounting end 12b, respectively. As further shown in FIG. 8A, the doctor blade assembly 10c in the partially aligned position 64c shows each fastener member 16, alignment through hole 46c, and recessed opening 48 in a first alignment path 72c (see FIG. 8B) with each other, and aligned with a positioning pin 70 in the toner hopper 56c.

FIG. 8B shows an enlarged front perspective view of the circle 8B of FIG. 8A showing an alignment element 40, such as in the form of alignment element 40c, and a recessed opening 48, such as in the form of recessed opening 48c, both with a triangle shape 100. As shown in FIG. 8B, the fastener member 16, alignment through hole 46c of the alignment element 40, and open portion 50c of the recessed opening 48, are aligned with the positioning pin 70 in a first alignment path 72c. The alignment element 40 and the recessed opening 48 are also aligned at a second alignment path 74c and a third alignment path 76c. As further shown in FIG. 8B, the alignment element 40 further comprises a front side 58c and a back side 60c, and the recessed opening 48c comprises an outer profile shape 77c, an inner profile shape 78c, first angled sidewall 104a, a second angled sidewall 104b, and a third angled sidewall 104c.

FIG. 8C shows a front perspective view of the doctor blade assembly 10c of FIG. 8A in a desired alignment position 80c in a toner hopper 56c and shows the doctor blade assembly 10c fully aligned in the toner hopper 56c. As shown in FIG. 8C, each alignment element 40, such as in the form of alignment element 40c, is attached with the fastener member 16 to the holder portion 18b and is in a fully attached position 82c such that the surface of the alignment element 40 is preferably flush with the surface of the first mounting end 12a (see FIG. 8A) and flush with the surface of the second mounting end 12b (see FIG. 8A) of the holder portion 18c. The doctor blade assembly 10c (see FIG. 8C) does not require use of a spacing element 36 (see FIG. 3A) or a fixture element 37 (see FIG. 3A) to align or to adjust the desired alignment position 80c (see FIG. 8C) of the doctor blade assembly 10c in the toner hopper 56c (see FIG. 8C) of the toner printer cartridge 11 (see FIG. 4D).

FIG. 9 shows an enlarged back perspective view of the alignment element 40, such as in the form of alignment element 40c, having a triangle shape 100. As shown in FIG. 9, the alignment element 40c shows first outer edge 102a, second outer edge 102b, third outer edge 102c, inner edges 106, and first angled or beveled sidewall 108a, second angled or beveled sidewall 108b, and third angled or beveled sidewall 108c.

FIG. 5A shows a front plan view of an embodiment of an alignment element 40, such as in the form of alignment element 40a, having a rectangle shape 44, having a height (x) 84 measured from a first edge 42a to a third edge 42c, and having a predetermined alignment position 41a. FIG. 5A further shows a symmetry line measurement position 86 at a height (x/2) 88a used in determining the predetermined alignment position 41a of the alignment through hole 46a. FIG. 5A further shows a second edge 42b, a fourth edge 42d, an inner profile 79a, a first angled or beveled sidewall 43a, a second angled or beveled sidewall 43b, a third angled or beveled sidewall 43c, and a fourth angled or beveled sidewall 43d.

FIG. 5B shows a front plan view of another embodiment of an alignment element 40, such as in the form of alignment element 40a, having a rectangle shape 44, having a height (x) 84, and having a predetermined alignment position 41b. FIG. 5B further shows a symmetry line measurement position 86 at a height (x/3) 88b used in determining the predetermined alignment position 41b of the alignment through hole 46a. FIG. 5B further shows an inner profile 79a, a first angled or beveled sidewall 43a, a second angled or beveled sidewall 43b, a third angled or beveled sidewall 43c, and a fourth angled or beveled sidewall 43d.

FIG. 5C shows a front plan view of another embodiment of an alignment element 40, such as in the form of alignment element 40a, having a rectangle shape 44, having a height (x) 84, and having a predetermined alignment position 41c. FIG. 5C further shows a symmetry line measurement position 86 at a height (x/4) 88c used in determining the predetermined alignment position 41c of the alignment through hole 46a. FIG. 5C further shows an inner profile 79a, a first edge 42a, a first angled or beveled sidewall 43a, a second angled or beveled sidewall 43b, a third angled or beveled sidewall 43c, and a fourth angled or beveled sidewall 43d.

FIG. 7A shows a front plan view of an embodiment of an alignment element 40, such as in the form of alignment element 40b, having a trapezoid shape 90, having a height (x) 94 measured from a first untapered edge 91a to a second untapered edge 91b, and having a predetermined alignment position 43a. FIG. 7A further shows a symmetry line measurement position 86 at a first height (x/4) 96a used in determining the predetermined alignment position 43a of the alignment through hole 46b. FIG. 7A further shows a first tapered edge 92a, a second tapered edge 92b, an inner profile 79b, a first angled or beveled sidewall 93a, a second angled or beveled sidewall 93b, a third angled or beveled sidewall 93c, and a fourth angled or beveled sidewall 93d.

FIG. 7B shows a front plan view of an embodiment of an alignment element 40, such as in the form of alignment element 40b, having a trapezoid shape 90, having a height (x) 94 measured from the first untapered edge 91a to the second untapered edge 91b, and having a predetermined alignment position 43b. FIG. 7B further shows a symmetry line measurement position 86 at a first height (x/3) 96b used in determining the predetermined alignment position 43b of the alignment through hole 46b. FIG. 7B further shows a first tapered edge 92a, a second tapered edge 92b, an inner profile 79b, a first angled or beveled sidewall 93a, a second angled or beveled sidewall 93b, and a third angled or beveled sidewall 93c.

FIG. 7C shows a front plan view of an embodiment of an alignment element 40, such as in the form of alignment element 40b, having a trapezoid shape 90, having a height (x) 94, and having a predetermined alignment position 43c. FIG. 7C further shows a symmetry line measurement position 86 at a height (x/2) 96c used in determining the predetermined alignment position 43c of the alignment through hole 46b. FIG. 7C further shows an inner profile 79b.

FIG. 7D shows a front plan view of an embodiment of an alignment element 40, such as in the form of alignment element 40b, having a trapezoid shape 90, having a height (x) 94, and having a predetermined alignment position 43d. FIG. 7D further shows a symmetry line measurement position 86 at a second height (x/3) 96d used in determining the predetermined alignment position 43d of the alignment through hole 46b. FIG. 7C further shows an inner profile 79b.

FIG. 7E shows a front plan view of an embodiment of an alignment element 40, such as in the form of alignment element 40b, having a trapezoid shape 90, having a height (x) 94, and having a predetermined alignment position 43e. FIG. 7E further shows a symmetry line measurement position 86 at a second height (x/4) 96e used in determining the predetermined alignment position 43e of the alignment through hole 46b. FIG. 7C further shows an inner profile 79b.

FIG. 10A shows an enlarged partial front perspective view of an embodiment of the doctor blade assembly 10a in a pre-aligned position 62 and showing a cut-out portion 39 prior to being formed into an alignment element 40, such as in the form of alignment element 40a, having a rectangle shape 44, and having an alignment through hole 46a formed in the alignment element 40. FIG. 10A further shows the alignment element 40 having the predetermined alignment position 41a, having the first angled or beveled sidewall 43a, the second angled or beveled sidewall 43b, the third angled or beveled sidewall 43c, and the fourth angled or beveled sidewall 43d. FIG. 10A further shows the insertion and removal path 55 from the alignment element 40 to the recessed opening 48, such as in the form of recessed opening 48a, having a rectangle shape. As shown in FIG. 10A, the recessed opening 48 has open portion 50a, and first angled sidewall 52a, second angled sidewall 52b, third angled sidewall 52c, and fourth angled sidewall 52d.

FIG. 10B shows a right side view of the doctor blade assembly 10a of FIG. 10A in a partially aligned position 64a. As shown in FIG. 10B, the alignment element 40, such as in the form of alignment element 40a, has a front side 58a, a back side 60a, and an alignment through hole 46a. The alignment element 40 is aligned along first alignment path 72a through the recessed opening 48, such as in the form of recessed opening 48a. FIG. 10B further shows first angled sidewall 52a and third angled sidewall 52c, formed in the first elongated positioning portion 110 of holder portion 18a. The blade portion 20a is shown adjacent the first elongated positioning portion 110 and a height 114 from the bottom of the blade portion 20a to the first alignment path 72a is important in determining where the alignment through hole 46a is positioned through the alignment element 40.

FIG. 10C shows a right side view of the doctor blade assembly 10a of FIG. 10B in a desired alignment position 80a in contact with a developer roller 116 and aligned in a toner hopper 56a in a toner printer cartridge 11. FIG. 10C shows the fastener member 16, such as in the form of screw 16a, inserted through the alignment element 40a and through the recessed opening 48a. Preferably, the fastener member 16 has a shaft length 109 greater than a thickness 111 of the alignment element 40a and the recessed opening 48a. As further shown in FIG. 10C, when the alignment element 40a is aligned and inserted within the corresponding recessed opening 48a at the desired alignment position 80a, the doctor blade assembly 10a is in a set position 120 with respect to the developer roller 116, so that the blade portion 20a contacts the developer roller 116 at desired contact location 118 to regulate the amount of toner 119 on the developer roller 116 and to give charge to the toner 119.

FIG. 10D shows an enlarged partial front perspective view of another embodiment of the doctor blade assembly 10a before it is aligned and showing the alignment element 40, such as in the form of alignment element 40a, having a rectangle shape 44, and having an alignment through hole 46a formed in the alignment element 40 and formed through the first elongated positioning portion 110 of the holder portion 18a. FIG. 10D further shows the alignment element 40 having the predetermined alignment position 41b, having the front side 58a, the back side 60a, the first angled or beveled sidewall 43a, the second angled or beveled sidewall 43b, the third angled or beveled sidewall 43c, and the fourth angled or beveled sidewall 43d. FIG. 10D further shows the insertion and removal path 55 from the alignment element 40 to the recessed opening 48, such as in the form of recessed opening 48a, having a rectangle shape. As shown in FIG. 10D, the recessed opening 48 has open portion 50a, and first angled sidewall 52a, second angled sidewall 52b, third angled sidewall 52c, and fourth angled sidewall 52d.

FIG. 10E shows an enlarged front perspective view of another embodiment of a doctor blade assembly 10d of the disclosure before it is aligned and showing the alignment element 40, such as in the form of alignment element 40d, having a rectangle shape 44, having a larger alignment through hole formed in the alignment element 40, and having straight sidewalls, including first straight sidewall 122a, second straight sidewall 122b, third straight sidewall 122c, and fourth straight sidewall 122d. As shown in FIG. 10E, this embodiment requires a sufficiently large fastener member 16, such as in the form of bolt 16b, that needs to be sufficiently large enough to secure the alignment element 40 within the recessed opening 48, such as recessed opening 48d, having a rectangle shape 44. FIG. 10E further shows the recessed opening 48 having an outer profile shape 77d, an inner profile shape 78d, the first straight sidewall 124a, the second straight sidewall 124b, the third straight sidewall 124c, and the fourth straight sidewall 124d. FIG. 10E further shows the insertion and removal path 55 from the alignment element 40 to the recessed opening 48.

There is provided in another embodiment a toner printer cartridge 11 (see FIG. 4B). The toner printer cartridge 11 (see FIG. 4B) comprises a toner hopper 56a (see FIG. 4BD). The toner printer cartridge 11 further comprises a doctor blade assembly 10a (see FIG. 4B) for alignment on the toner hopper 56a. The doctor blade assembly 10a comprises a holder portion 18a (see FIG. 4B). The holder portion 18a comprises a first elongated positioning portion 110 (see FIG. 4A) having a first mounting end 12a (see FIG. 4A) and a second mounting end 12b (see FIG. 4A), a second elongated positioning portion 112 (see FIG. 4A) substantially perpendicular to the first elongated positioning portion 110 (see FIG. 4A), a pair of recessed openings 48 (see FIG. 4A) formed in the first mounting end 12a and the second mounting end 12b, respectively, a pair of alignment elements 40 (see FIG. 4A) each having an alignment through hole 46a (see FIG. 4A) and each configured to fit in and correspond to each respective recessed opening 48. Each alignment element 40a, 40b, 40c and each recessed opening 48a, 48b, 48c has a corresponding outer profile in a shape including a rectangle shape 44 (see FIG. 4B), a trapezoid shape 90 (see FIG. 6A), a triangle shape 100 (see FIG. 8A),), a square shape (not shown), a pentagon shape (not shown), a hexagon shape (not shown), a circle shape (not shown), an oval shape (not shown), or another suitable shape. Each alignment element 40 has a plurality of angled sidewalls or a plurality of straight sidewalls. The doctor blade assembly 10a (see FIG. 4A) further comprises a blade portion 20a (see FIG. 4A) attached along the first elongated positioning portion 110 (see FIG. 4A) between the pair of recessed openings 48 (see FIG. 4A). The doctor blade assembly 10a (see FIG. 4A) further comprises a pair of fastener members 16 (see FIG. 4A) each configured for insertion through the alignment through hole 46a (see FIG. 4A) of the alignment elements 40 (see FIG. 4A) and through the recessed openings 48 (see FIG. 4A). The doctor blade assembly 10a (see FIG. 4A) does not require use of a spacing element 36 (see FIG. 3A) or a fixture element 37 (see FIG. 3A) to align or to adjust the doctor blade assembly 10a position in the toner hopper 56a (see FIG. 4B) of the toner printer cartridge 11 (see FIG. 4A).

There is provided in another embodiment a method 200 (see FIG. 11) for aligning a doctor blade assembly 10a (see FIG. 4A) in a toner hopper 56a (see FIG. 4B) of a toner printer cartridge 11 (see FIG. 4B). FIG. 11 shows an illustration of a flow diagram of an embodiment of the method 200 of the disclosure. The method 200 comprises step 202 of cutting a pair of recessed openings 48 (see FIGS. 4A, 10A) through a first mounting end 12a (see FIG. 4A) and a second mounting end 12b (see FIG. 4A) of a holder portion 18a (see FIG. 4A) of a doctor blade assembly 10a (see FIG. 4A), and obtaining a pair of removable cut-out portions 39 (see FIG. 10A) corresponding to the pair of recessed openings 48 (see FIG. 4A). The cutting step 202 may be performed with a known cutting process comprising a laser cutting process, a drilling process, a plasma arc cutting process, a water jet cutting process, an oxyfuel cutting process, a die cutting process, an etch cutting process, or another suitable known cutting process. The cutting step 202 may comprise cutting a plurality of angled sidewalls 52 (see FIG. 4A) for each recessed opening 48 (see FIG. 4A), cutting a plurality of straight sidewalls 124a, 124b, 124c, 124d (see FIG. 10E) for each recessed opening 48 (see FIG. 10E), or cutting a combination of one or more angled sidewalls 52 (see FIG. 4C) and one or more straight sidewalls 124a, 124b, 124c, 124d (see FIG. 10E). Each recessed opening 48 and each alignment element 40 preferably have the same number or plurality of angled sidewalls, straight sidewalls, or combination of angled sidewalls and straight sidewalls. The cutting step 202 preferably comprises cutting an outer profile 77a (see FIG. 4C) of each recessed opening 48 (see FIG. 4C) in a shape including a rectangle shape 44 (see FIG. 4B), a trapezoid shape 90 (see FIG. 6A), a triangle shape 100 (see FIG. 8A),), a square shape (not shown), a pentagon shape (not shown), a hexagon shape (not shown), a circle shape (not shown), an oval shape (not shown), or another suitable shape.

As shown in FIG. 11, the method 200 further comprises step 204 of forming a predetermined alignment through hole 46a (see FIGS. 4A, 10A) in each of the cut-out portions 39 (see FIG. 10A), and obtaining an alignment element 40a (see FIGS. 4A, 10A). The forming step 204 preferably comprises forming the alignment through hole 46a (see FIGS. 5A-5C and 7A-7E) at a location in the alignment element 40 (see FIGS. 5A-5C and 7A-7E) based on a determination of a symmetry line measurement position 86 (see FIGS. 5A-5C and 7A-7E) including a height measurement 84 (see FIGS. 5A-5C) or a height measurement 94 (see FIGS. 7A-7E) of the alignment element 40 divided by two (x/2) (see FIGS. 5A, 7C), a height measurement 84 (see FIG. 5B) or a height measurement 94 (see FIGS. 7B, 7D) of the alignment element 40 divided by three (x/3) (see FIGS. 5B, 7B, 7D), or a height measurement 84 (see FIG. 5C) or a height measurement 94 (see FIGS. 7A, 7E) of the alignment element 40 divided by four (x/4) (see FIGS. 5C, 7A, 7E).

As shown in FIG. 11, the method 200 further comprises step 206 of positioning the doctor blade assembly 10a (see FIG. 4B) in a toner hopper 56a (see FIG. 4B) of a toner printer cartridge 11 (see FIG. 4B), wherein the toner hopper 56a has a pair of positioning pins 70 (see FIGS. 4B, 4C) at each end 35a, 35b (see FIG. 4B) of the toner hopper 56a.

As shown in FIG. 11, the method 200 further comprises step 208 of aligning the respective alignment through holes 46a (see FIG. 4B), the recessed openings 48 (see FIG. 4B), and the positioning pins 70 (see FIG. 4B) along a substantially straight alignment pathway 72a (see FIGS. 4B, 4C). The positioning step 206 and the aligning step 208 do not require use of a spacing element 36 (see FIG. 3A) or a fixture element 37 (see FIG. 3A) to adjust a desired alignment position 80a (see FIG. 4D) of the doctor blade assembly 10a (see FIG. 4D) on the toner hopper 34 (see FIG. 4D) of the toner printer cartridge 11 (see FIG. 4D).

As shown in FIG. 11, the method 200 further comprises step 210 of inserting a pair of fastener members 16 (see FIGS. 4B-4C) through the respective alignment through holes 46a (see FIG. 4B) and the recessed openings 48 (see FIG. 4B) to set the doctor blade assembly 10a (see FIG. 4D) at a desired alignment position 80a (see FIG. 4D). The inserting step 210 preferably comprises inserting each fastener member 16 (see FIGS. 4B-4C and FIG. 10C) having a shaft length 109 (see FIG. 10C) greater than a thickness 111 (see FIG. 10C) of each alignment element 40 and each recessed opening 48 (see FIG. 10C). The shaft length 109 must be long enough to fasten the doctor blade assembly 10a to the toner printer cartridge 11.

The alignment element 40 (see FIG. 4A) is designed to prevent misalignment of the doctor blade assembly 10a in the toner hopper 56a (see FIG. 4D). The doctor blade assembly 10a and method 200 may be used to prepare alignment elements 40 for testing and test various doctor blade assemblies 10a with various alignment element 40 positions. The doctor blade assembly 10a and method 200 may be used to test various combinations of the alignment element 40 and the blade portion 20a (see FIG. 4A) to find out the optimal position for the blade portion 20a and the doctor blade assembly 10a. In addition, doctor blade assembly 10a and method 200 enable easy adjustment when various toners with different characteristics are used.

It can now be realized that the doctor blade assembly 10a (see FIG. 4A), 10b (see FIG. 6A), 10c (see FIG. 8A), and method 200 (see FIG. 11) disclosed herein provide numerous advantages over known devices and methods, including but not limited to the following: provides an assembly and method that that effectively aligns and positions the doctor blade assembly with respect to the toner hopper and proximate to the developer roller (or mag roller) during assembly, manufacture, and remanufacture, which may be beneficial in allowing the doctor blade assembly to regulate the toner amount on the developer roller (or mag roller), and which may result in maximizing print quality during printing; provides a device and method that does not require the use of permanently attached spacing elements or spacers, inserts, shims, or other spacing elements and does not require the use of fixture elements to hold the doctor blade assembly, both which may increase the overall cost and complexity and decrease the overall efficiency of the assembly, manufacturing, or remanufacturing processes; provides an assembly and method that aligns and positions a doctor blade within a toner hopper or a portion of a remanufactured toner printer cartridge to maximize printing quality of the remanufactured toner printer cartridge when it is in use with a laser printer device (not shown); provides an assembly and method that aligns and positions the doctor blade during replacement and remanufacture accurately and efficiently to an acceptable alignment or position point to maximize print quality during printing; provides an assembly and method that may only require a one time setting to set a doctor blade alignment setting, thus increasing efficiency and decreasing cost; provides an assembly and method having a unique cut-out alignment element designed to prevent misalignment, and makes alignment of the doctor blade assembly easier and more reproducible; and, provides an assembly and method for aligning a doctor blade assembly in a desired position to regulate the developer layer on a developer roller in the toner printer cartridge, process cartridge or image forming device or apparatus.

Many modifications and other embodiments of the disclosure will come to mind to one skilled in the art to which this disclosure pertains having the benefit of the teachings presented in the foregoing descriptions and the associated drawings. The embodiments described herein are meant to be illustrative and are not intended to be limiting. The invention is not limited in its application to the details of the construction and to the arrangement of the components set forth in the above description or as illustrated in the drawings.

What is claimed is:

1. A doctor blade assembly for alignment in a toner hopper of a toner printer cartridge, the doctor blade assembly comprising:
a holder portion comprising:
a first mounting end and a second mounting end;
a pair of recessed openings formed in the first mounting end and the second mounting end, respectively;
a pair of alignment elements each having an alignment through hole and each configured to fit in and correspond to each respective recessed opening;
a blade portion attached to the holder portion; and,
a pair of fastener members each configured for insertion through the alignment through hole and through the recessed opening.

2. The doctor blade assembly of claim 1 wherein each recessed opening and each alignment element have a same plurality of angled sidewalls.

3. The doctor blade assembly of claim 1 wherein each recessed opening and each alignment element have a same plurality of straight sidewalls.

4. The doctor blade assembly of claim 1 wherein each recessed opening and each alignment element have a same outer profile in a shape selected from a group consisting of a rectangle, a trapezoid, a triangle, a square, a pentagon, a hexagon, a circle, and an oval.

5. The doctor blade assembly of claim 1 wherein the holder portion comprises a first elongated positioning portion and a second elongated positioning portion substantially perpendicular to the first elongated positioning portion, the first elongated positioning portion having the first mounting end and the second mounting end.

6. The doctor blade assembly of claim 5 wherein the blade portion is attached along the first elongated positioning portion between the pair of recessed openings.

7. The doctor blade assembly of claim 1 wherein each fastener member has a length greater than a thickness of each alignment element.

8. The doctor blade assembly of claim 1 wherein the alignment through hole is formed in the alignment element at a symmetry line measurement position selected from a group consisting of a height measurement of the alignment element divided by two, a height measurement of the alignment element divided by three, and a height measurement of the alignment element divided by four.

9. The doctor blade assembly of claim 1 wherein the doctor blade assembly does not require use of a spacing element or a fixture element to align or to adjust a desired alignment position of the doctor blade assembly in the toner hopper of the toner printer cartridge.

10. A toner printer cartridge comprising:
a toner hopper; and,
a doctor blade assembly for alignment in the toner hopper, the doctor blade assembly comprising:
a holder portion comprising:
a first elongated positioning portion having a first mounting end and a second mounting end;
a second elongated positioning portion substantially perpendicular to the first elongated positioning portion;
a pair of recessed openings formed in the first mounting end and the second mounting end, respectively;
a pair of alignment elements each having an alignment through hole and each configured to fit in and correspond to each respective recessed opening;
a blade portion attached along the first elongated positioning portion between the pair of recessed openings; and,
a pair of fastener members each configured for insertion through the alignment through hole of the alignment elements and through the recessed openings,
wherein the doctor blade assembly does not require use of a spacing element or a fixture element to align or to adjust a desired alignment position of the doctor blade assembly in the toner hopper of the toner printer cartridge.

11. The toner printer cartridge of claim 10 wherein each alignment element and each recessed opening have a corresponding outer profile in a shape selected from a group consisting of a rectangle, a trapezoid, a triangle, a rectangle, a trapezoid, a triangle, a square, a pentagon, a hexagon, a circle, and an oval.

12. The toner printer cartridge of claim 10 wherein each alignment element has a plurality of angled sidewalls or a plurality of straight sidewalls.

13. A method for aligning a doctor blade assembly in a toner hopper of a toner printer cartridge, the method comprising the steps of:
cutting a pair of recessed openings through a first mounting end and a second mounting end of a holder portion of a doctor blade assembly, and obtaining a pair of removable cut-out portions corresponding to the pair of recessed openings;
forming a predetermined alignment through hole in each of the cut-out portions, and obtaining an alignment element;
positioning the doctor blade assembly in a toner hopper of a toner printer cartridge, wherein the toner hopper has a pair of positioning pins at each end;
aligning the respective alignment through holes, the recessed openings, and the positioning pins along a substantially straight alignment pathway; and,
inserting a pair of fastener members through the respective alignment through holes and the recessed openings to set the doctor blade assembly in a desired alignment position.

14. The method of claim 13 wherein the cutting step is performed with a cutting process comprising a laser cutting process, a drilling process, a plasma arc cutting process, a water jet cutting process, an oxyfuel cutting process, a die cutting process, and an etch cutting process.

15. The method of claim 13 wherein the step of cutting the pair of recessed openings comprises cutting a plurality of angled sidewalls for each recessed opening.

16. The method of claim 13 wherein the step of cutting the pair of recessed openings comprises cutting a plurality of straight sidewalls for each recessed opening.

17. The method of claim 13 wherein the step of cutting the pair of recessed openings comprises cutting an outer profile of each recessed opening in a shape selected from a group consisting of a rectangle, a trapezoid, a triangle, a rectangle, a trapezoid, a triangle, a square, a pentagon, a hexagon, a circle, and an oval.

18. The method of claim 13 wherein the step of forming the predetermined alignment through hole comprises forming the alignment through hole at a location in the alignment element based on a determination of a symmetry line measurement position selected from a group consisting of a height measurement of the alignment element divided by two, a height measurement of the alignment element divided by three, and a height measurement of the alignment element divided by four.

19. The method of claim 13 wherein the step of inserting the pair of fastener members comprises inserting each fastener member having a length greater than a thickness of each alignment element.

20. The method of claim 13 wherein the positioning and aligning steps do not require use of a spacer element or a fixture element to align or to adjust a desired alignment position of the doctor blade assembly in the toner hopper of the toner printer cartridge.
